(19) United States
(12) Patent Application Publication
(10) Pub. No.: US 2026/0060262 A1
(43) Pub. Date: Mar. 5, 2026

(54) SOFT COOKED EGG PRODUCT AND PROCESS

(71) Applicant: Cargill, incorporated, Wayzata, MN (US)

(72) Inventors: Olivia GEOGHEGAN, Davis, CA (US); Jonathan Mark GRIEBEL, Maple Grove, MN (US); Jill LUTZ, Elk River, MN (US); Donald Andrew MOSS, Elk River, MN (US); Scott A. WOODWARD, Brooklyn Park, MN (US)

(73) Assignee: Cargill, incorporated, Wayzata, MN (US)

(21) Appl. No.: 19/386,416

(22) Filed: Nov. 12, 2025

Related U.S. Application Data
(63) Continuation of application No. 17/617,965.
(60) Provisional application No. 62/860,567, filed on Jun. 12, 2019.

(51) Int. Cl. A23B 5/005; A23L 5/10; A23L 15/00

(52) U.S. Cl. CPC A23B 5/0057; A23L 5/17; A23L 15/00

(57) ABSTRACT

Soft cooked egg products having a runny yolk are prepared by removing the eggs from their shells; cooking so that the egg white has a temperature of no more than about 175° F. and the egg yolk has a temperature of no more than about 150° F.; cooling the egg to an internal temperature of 75° F. or less; sealing the egg in a package; and pasteurizing. Alternatively, the shell-less eggs are packaged sealed in a package and cooked so that the egg white has a temperature of no more than about 175° F. and the egg yolk has an internal temperature of no more than about 150° F. The processes are carried out under processing conditions such that the pasteurized, cooked, packaged eggs have runny yolks. Products made by this process are also described.

### CROSS-REFERENCE TO RELATED APPLICATIONS

This application is a Continuation of U.S. application Ser. No. 17/617,965, filed Dec. 10, 2021, which is a national phase of International Application No. PCT/US2020/037432, filed Jun. 12, 2020, which claims the benefit of Provisional Application No. 62/860,567, filed Jun. 12, 2019, each of which are incorporated by reference in its entirety.

### FIELD OF THE INVENTION

The present invention relates to egg products and processes for preparing same.

### BACKGROUND OF THE INVENTION

Various methods for cooking eggs are known, such as frying, poaching, hard boiling and soft boiling. Sous vide processes are also known. U.S. Pat. No. 6,187,348 describes a sous vide process and mentions eggs (in the shell) as a possible food product to be cooked by this process. U.S. Pat. No. 9,603,477 describes an appliance for home use and includes a discussion of cooking eggs that are whole and in the shell.

### SUMMARY OF THE INVENTION

Traditionally, consumers purchase individual food components and prepare desired dishes according to personal taste and need. However, current food trends place a high value both on convenience and on meeting consumer's ever increasing demand for quality of flavor, texture and visual appeal. Egg products may be easily provided to consumers in raw form. Cooked eggs may additionally be provided, for example, in hard boiled form (either in or out of the shell), or as cooked patties in the fresh or frozen state. A challenging product to provide as a convenience product on a mass production basis is the “soft cooked” egg product wherein the white is set and the yolk is runny to semi-gelled. For purposes of the present discussion, a yolk is considered runny to semi-gelled if, when cut vertically in half, a portion of the yolk visibly flows to contact the surface on which the egg is placed.

The egg white is cooked and set and does not flow. In an aspect of the present invention, the soft cooked egg product has the appearance of a sunny-side up egg (i.e. having the yolk visibly apparent on one side). In an aspect of the present invention, the soft cooked egg product has the appearance of a poached egg (i.e., having the white formed around the yolk, and appearing as if cooked in water). In an aspect of the present invention, the soft cooked egg product has the appearance of an over-easy egg product (i.e., having the white formed around the yolk, and appearing as if fried on both sides).

It has been found that soft cooked egg products having a runny to semi-gelled yolk (hereafter referred to as “runny yolk”) can be prepared on a mass production basis by a careful selection of process steps and conditions. In particular, one aspect of the process for preparing soft, cooked egg products having a runny yolk comprises:
a) Removing a plurality of eggs from their shells to provide shell-less eggs;
b) Cooking the shell-less eggs for a time and temperature sufficient to provide a cooked egg wherein the egg white has a maximum temperature of no more than about 175° F. and the egg yolk has a maximum internal temperature (temperature inside the yolk) of no more than about 150° F. to provide precooked eggs;
c) Cooling the cooked egg to an internal temperature (inside the yolk) of 75° F. or less;
d) Sealing the cooked egg in a package;
e) Pasteurizing the cooked, packaged egg; and
f) Optionally, cooling the pasteurized cooked, packaged egg to an internal temperature (inside the yolk) of less than 40° F.

In another aspect, a process for preparing soft cooked egg products having a runny yolk comprises:
a) Removing a plurality of eggs from their shells to provide shell-less eggs;
b) Depositing the shell-less egg into a rigid, semi-rigid, or flexible package;
c) Sealing the shell-less eggs in the package;
d) Cooking the packaged shell-less eggs for a time and temperature sufficient to provide a cooked egg wherein the egg white has a maximum temperature of no more than about 175° F. and the egg yolk has a maximum internal temperature of no more than about 150° F. to provide precooked eggs; and
e) Optionally, cooling the pasteurized cooked packaged egg to an internal temperature (inside the yolk) of less than 40° F.

The process is carried out under processing conditions such that the pasteurized, cooked, packaged eggs have runny yolks.

The soft cooked egg products made by aspects of the process surprisingly exhibit excellent organoleptic properties in flavor, texture and visual appeal, while at the same time affording convenience to the consumer. Products made in this manner are ready-to-eat (RTE), food safe, reheat quickly, give consistent degree of cooking. The consumer is provided with an extremely convenient soft cooked egg product having a runny yolk that is provided in a predictable degree of cooking and in a format that can be difficult to consistently prepare under typical working conditions in the industrial kitchen or the home environment. The present process provides a product having a reliable appearance, degree of done-ness, texture and flavor, which can be easily and quickly heated and presented for consumption by the diner.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this application, illustrate several aspects of the invention and together with a description of the embodiments serve to explain the principles of the invention. A brief description of the drawings is as follows:

FIG. 1 is a process diagram of an aspect of a process for preparing soft cooked egg products having a runny yolk as described herein.

FIG. 2 is a process diagram of an aspect of a process for preparing soft cooked egg products having a runny yolk as described herein.

FIG. 3 is a photograph of an aspect of the present soft cooked egg product that is a flat of connected, individually packaged eggs, with a single egg in each sealed skin pack package.

FIG. 4 is a photograph of an aspect of the present soft cooked egg product that are egg packages having either a single egg or two eggs in each sealed skin pack package.

FIG. 5 is a photograph of an aspect of the present soft cooked egg product that is an individual egg in a sealed modified atmosphere package.

FIG. 6 is a photograph of an aspect of the present soft cooked egg product that is a flat of connected, individually packaged eggs, with a single egg in each sealed vacuum compartment.

FIG. 7 is a photograph of an aspect of the present soft cooked egg product in a case with individually packaged eggs, with a single egg in each sealed modified atmosphere package.

FIG. 8 is a photograph of an aspect of the present soft cooked egg product that is a flat of connected, individually packaged eggs, with a single uncooked egg in each sealed skin pack package.

FIG. 9 is a photograph of an aspect of the present soft cooked egg product that is a flat of connected, individually packaged eggs, with a single cooked egg in each sealed skin pack package.

FIG. 10 is a photograph of an aspect of the present soft cooked egg product that shows the soft cooked eggs after cooking and removed from the package.

FIG. 11 is a graph of the egg temperature during a process for preparing a soft cooked egg product.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

Eggs prepared by the process as described herein may be any egg suitable for consumption as a soft cooked egg product. In an aspect, the eggs are sourced from fowl. In an aspect, the eggs are sourced from domesticated fowl. In an aspect, the eggs are sourced from poultry selected from chickens, turkeys, ducks and geese. In an aspect, the eggs are chicken eggs.

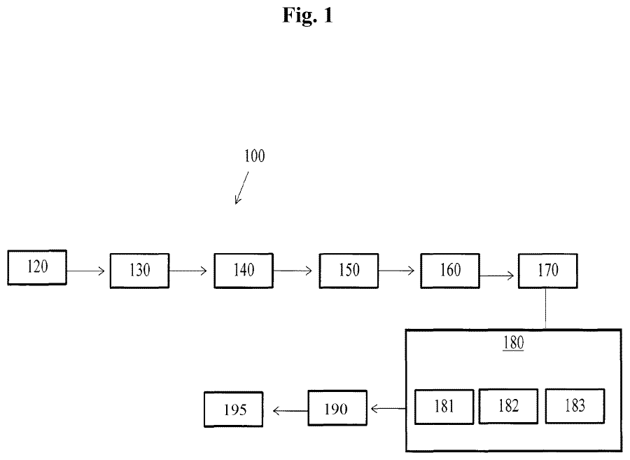

Turning now to the figures, FIG. 1 is a process diagram of an aspect of a process 100 for preparing soft cooked egg products having a runny yolk as described herein. Eggs are provided in their shells 120, and the contents of the plurality of eggs are removed from their shells to provide shell-less eggs in a Breaking Step 130, without breaking the yolks of the eggs. In an aspect, the plurality of eggs are removed from their shells by automated equipment. In an aspect, the contents of each single egg is maintained together as a unitary egg product. In an aspect, the egg yolks are separated from the egg whites for ease of handling and for preservation of usable egg white component in the event of rupture of the egg yolk. Then each individual intact egg yolk is combined with a quantity of egg white in a ratio generally corresponding to the natural ratio of a typical egg. The thus provided shell-less eggs are deposited in individual cooking vessels in Depositing Step 140, such as shallow pans or oven-able cups, for conveyance through subsequent cooking and cooling steps as described herein.

The thus provided shell-less eggs are cooked in Cooking Step 150 for a time and temperature sufficient to provide a cooked egg wherein the egg white has a maximum temperature of no more than about 175° F. and the egg yolk has a maximum temperature of no more than about 150° F. to provide precooked eggs (temperature taken inside the yolk, i.e., internal temperature). In an aspect, the cooked egg white has a maximum temperature of no more than about 170° F. and the egg yolk has a maximum internal temperature of no more than about 145° F. In an aspect, the cooked egg white has a temperature of from about 160° F. to about 170° F. and the egg yolk has an internal temperature of about 140° F. to about 145° F. In an aspect, the eggs are cooked at a locally ambient cooking temperature (i.e., the oven temperature, also referred to as the ambient oven cooking temperature herein) of from 160° F. to 450° F. In an aspect, the eggs are cooked at an ambient oven cooking temperature of from 170° F. to 300° F. In an aspect, the eggs are cooked at an ambient oven cooking temperature of from 180° F. to 220° F. In an aspect, the eggs are cooked at an ambient oven cooking temperature of from 190° F. to 220° F. In an aspect, the eggs are cooked at an ambient oven cooking temperature of from 190° F. to 200° F. In an aspect, the eggs are cooked at an ambient oven cooking temperature of from 192° F. to 198° F. In an aspect, the eggs are cooked at an ambient oven cooking temperature of from 192°F. to 197° F. In an aspect, the eggs are cooked at an ambient oven cooking temperature of 195° F. or about 195° F. In an aspect, the eggs are cooked for a time of 4 to 8 minutes at an egg temperature of at least 140° F. (i.e., the eggs are held at an internal temperature of at least 140° F. for a time of 4 to 8 minutes during the Cooking Step 150). In an aspect, the eggs are cooked for a time of 5 to 7 minutes at an egg temperature of at least 140° F.

In an aspect, the eggs are cooked in Cooking Step 150 in an impingement oven at an oven temperature of from about 300° F. to 450° F.

Impingement ovens are commercially available, such as the LINCOLN impingement oven, Fort Wayne, Indiana; and the MIDDLEBY MARSHALL impingement oven, Elgin, Illinois.

In an aspect, the eggs are cooked at a locally ambient cooking temperature (e.g. oven temperature) of from 160° F. to 450° F. and at a steam pressure of from about 3 to 10 lbs. steam. In an aspect, the eggs are cooked in Cooking Step 150 for a time of from 3 to 10 minutes.

In an aspect, the eggs are cooked in Cooking Step 150 in a conventional oven or a convection oven. In an aspect, the eggs are cooked in Cooking Step 150 under dry heat conditions. For purposes of the present discussion, “dry heat” cooking is heating at a relative humidity of from about 5 to 10% using dry and wet bulb thermometer. In an aspect, the dry heat is provided by passage of the shell-less eggs through a continuous oven, whereby the pans of shell-less eggs are place on a conveyor system, such as a conveyor belt, and passed through a heating zone.

In an aspect, the eggs are cooked in Cooking Step 150 in steam for a time of from about 60 seconds to 120 seconds to provide cooked eggs. For purposes of the present discussion, cooking in steam is heating at a relative humidity of from about 30% to 50%, measured with electronic sensors. In an aspect, Cooking step 150 is carried out at a cooking temperature of from 160° F. to 300° F. Any suitable apparatus for carrying out the steam cooking may be used, such as RATIONAL combi ovens, Landsberg am Lech, Germany. Another example would be a commercial spiral steam oven from Marlen International, Kansas City, MO.

In an aspect, the steam cooking is provided by passage of the shell-less eggs through a continuous steam oven, whereby the pans of shell-less eggs are place on a conveyor system, such as a conveyor belt, and passed through a steam heating zone.

In an aspect of the present invention, the soft cooked egg product has the appearance of a sunny-side up egg (i.e. having the yolk visibly apparent on one side). In this aspect, the egg is cooked without turning the egg over. In an aspect of the present invention, the soft cooked egg product is cooked in water and turned over and cooked before being inserted into the package, so that the egg has the appearance of a poached egg (i.e. having the white formed around the yolk, and appearing as if cooked in water). In an aspect of the present invention, the soft cooked egg product is cooked on a cooking surface and turned over and cooked before being inserted into the package, so that the egg has the appearance of an over-easy egg product (i.e. having the white formed around the yolk, and appearing as if fried on both sides).

The cooked egg is then cooled in Cooling Step 160. In an aspect the cooked egg is cooled to an internal temperature of 75° F. or less. In an aspect the cooked egg is cooled to an internal temperature of from about 60 to about 75° F. In an aspect the cooked egg is cooled to an internal temperature of about 50° F. to about 60° F. In an aspect, the cooling is carried out in a blast chilling tunnel. It has been found that the step of cooling the cooked egg is important, because cooling is advantageous in preserving the integrity of the yolk. If the eggs are not cooled to a low enough temperature, the yolks of the eggs are more likely to rupture when the eggs are packaged under vacuum.

After Cooking Step 150, the cooked egg is optionally sprayed with water or oil 170 prior to being sealed in a gas impermeable package in sealing step 180. In an aspect, the cooked egg is treated by application of water or oil in Step 170 to the surface of the yolk. In an aspect, the cooked egg is treated by application of water or oil to the surface of the yolk after the Cooking Step 150 and before Cooling Step 160. In an aspect, the cooked egg is treated by application of water or oil to the surface of the yolk after Cooling Step 160 and before Sealing Step 180. It has been found that application of water or oil to the surface of the yolk is advantageous in avoiding sticking of the yolk to the packaging, which can lead to premature tearing of the yolk during the sealing process, during storage, and/or when the cooked egg product is removed by the ultimate consumer.

After Cooling Step 160 (either with or without the cooked optional step of being sprayed with water or oil 170), the cooled egg is sealed in a package in sealing step 180 by any appropriate sealing technique. In an aspect, the sealing step 180 is carried out wherein the cooked egg is sealed in a package where air is replaced and flushed with modified atmosphere 181. In an aspect, the package is flushed with an inert gas. In an aspect, the inert gas comprises at least one gas selected from carbon dioxide, nitrogen, or oxygen. In an aspect, the inert gas comprises a mixture of at least two of carbon monoxide, carbon dioxide, or nitrogen. In an aspect, the inert gas comprises carbon dioxide and nitrogen, e.g., about 20-40% carbon dioxide and about 80-20% nitrogen (e.g., 60% nitrogen and 40% carbon dioxide), to help maintain the integrity of the egg and enhance the shelf life of the pasteurized, cooked egg products. In an aspect, the resulting package when the sealing step 180 is sealing with modified atmosphere 181 is a pillow pack.

In an aspect, the sealing step 180 is carried out wherein the cooked egg is vacuum sealed in a vacuum package 182. In an aspect, the vacuum package is a pouch package. In an aspect, the cooked egg is vacuum sealed under a vacuum of from 1 to 200 mbar. In an aspect, the cooked egg is vacuum sealed under a vacuum of vacuum of from 1 to 100 mbar.

In an aspect, the sealing step 180 is carried out wherein the cooked egg is vacuum skin packaging step 183. In vacuum skin packaging step 183, the cooked egg is placed on a substrate that retains its shape during the sealing step, and is covered by a sheet of film that is softened with heat under vacuum, so that the film closely conforms to the shape of the cooked egg and encloses and seals the product within the film and the substrate. In an aspect, the sheet of film is a sheet of transparent film. In an aspect, the tray is a plastic tray.

The cooked, packaged egg is then pasteurized in Pasteurization Step 190 by any appropriate pasteurization process. In an aspect, the cooked, packaged egg is pasteurized by gamma irradiation. In an aspect, the cooked, packaged egg is pasteurized by a High-Temperature-Short-Time Treatment (HTST), such as being exposed to a temperature of about 180° F. to 200° F. for from 10 to 20 seconds. In an aspect, the cooked, packaged egg is pasteurized by Low-Temperature-Long-Time Treatment (LTLT), such as being exposed to a temperature of from about 130° F. to 145° F. for a period of from 2 to 30 minutes. In an aspect, the cooked, packaged egg is pasteurized by immersion in a heated liquid at a temperature of from about 140° F. to 145° F. for a period of from 2 to 20 minutes. In an aspect, the heated liquid is water. In an aspect, the cooked, packaged egg is pasteurized by High Pressure Pasteurization (HPP), such as being exposed to a pressure of 300 to 600 MPa at a temperature of about 40° F. to 150° F. for about 2 to 4 minutes.

In an aspect, the pasteurized cooked, packaged egg is optionally chilled in a Second Chilling Step 195. In an aspect, the pasteurized cooked, packaged egg is chilled in Second Chilling Step 195 to a temperature that is not greater than about 40° F. In an aspect, the pasteurized cooked, packaged egg is chilled in Second Chilling Step 195 to a temperature that is from about 35° F. to about 40° F.

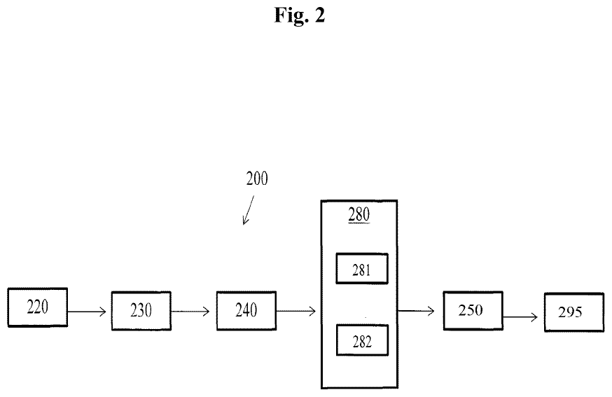

FIG. 2 is a process diagram of a process 200, which is another aspect for preparing soft cooked egg products having a runny yolk as described herein. In this process, eggs are provided in their shells 220, and the contents of the plurality of eggs are removed from their shells to provide shell-less eggs in a Breaking Step 230, without breaking the yolks of the eggs. The plurality of eggs are removed from their shells by a suitable process, for example, as described in process 100 as described above. The thus provided shell-less eggs are deposited in individual cooking vessels in Depositing Step 240, such as shallow pans, oven-able cups, or flexible packaging, for conveyance through subsequent cooking and cooling steps by processes, for example, as described in process 100 as described above. In an aspect, the shallow pans, oven-able cups, and/or flexible packaging comprise a food-grade polymer.

The shell-less eggs in the individual cooking vessels are optionally sprayed with water or oil in a manner similar to that described in process 100, as described above, prior to being sealed in a package in sealing step 280 by any appropriate sealing technique. In an aspect, the sealing step 280 is carried out wherein the cooked egg is sealed in a package where air is replaced and flushed with modified atmosphere 281. In an aspect, the package is flushed with an inert gas. In an aspect, the inert gas comprises at least one gas selected from carbon dioxide, nitrogen, or oxygen. In an aspect, the inert gas comprises a mixture of at least two of carbon monoxide, carbon dioxide, or nitrogen. In an aspect, the inert gas comprises carbon dioxide and nitrogen, e.g., about 20-40% carbon dioxide and about 80-20% nitrogen (e.g., 60% nitrogen and 40% carbon dioxide), to help maintain the integrity of the egg and enhance the shelf life of the pasteurized, cooked egg products. In an aspect, the resulting package when the sealing step 280 is sealing with modified atmosphere 281 is a pillow pack.

In an aspect, the sealing step 280 is carried out wherein the cooked egg is vacuum sealed in a vacuum package 282. In an aspect, the vacuum package is a pouch package. In an aspect, the cooked egg is vacuum sealed under a vacuum of from 1 to 200 mbar. In an aspect, the cooked egg is vacuum sealed under a vacuum of from 1 to 100 mbar. In an aspect, the cooked egg is vacuum sealed under a vacuum of from 20 to 90 mbar; or under a vacuum of from 20 to 50 mbar; or under a vacuum of from 50 to 90 mbar. In an aspect, the cooked egg is vacuum sealed under a vacuum of from 200 mbar to 1000 mbar for a time of from 3 to 20 seconds. In an aspect, the cooked egg is vacuum sealed under a vacuum of from 800 mbar to 1000 mbar for a time of from 5 to 15 seconds.

The thus provided packaged, shell-less eggs are cooked in Cooking Step 250 for a time and temperature sufficient to provide a cooked egg wherein the egg white has a maximum temperature of no more than about 175° F. and the egg yolk has a maximum temperature of no more than about 150° F. to provide precooked eggs (temperature taken inside the yolk, i.e., internal temperature). The packaged, shell-less eggs are cooked in Cooking Step 250 by a suitable process, for example, as described in process 100 as described above.

In an aspect, the pasteurized cooked, packaged egg is optionally chilled in a Chilling Step 295.

In an aspect, the pasteurized cooked, packaged egg is chilled in Chilling Step 295 to a temperature that is not greater than about 40° F. In an aspect, the pasteurized cooked, packaged egg is chilled in Chilling Step 295 to a temperature that is from about 35° F. to about 40° F.

The process described in process 200 advantageously requires only one cooking step prior to making the final product available to the customer, and does not require a separate pasteurization step. This is because the egg is sealed in a gas impermeable package prior to heating to a temperature effective to both pasteurize and to cook the eggs.

As noted above, the process is carried out under processing conditions such that the pasteurized, cooked, packaged eggs have runny yolks.

In an aspect, each package comprises a single egg. In an aspect, each package comprises a plurality of eggs. In an aspect, each package comprises two eggs. In an aspect, each package comprises from two to 20 eggs. In an aspect, each package comprises from two to 12 eggs. In an aspect, each package comprises from two to 10 eggs. In an aspect, each package comprises from two to 6 eggs. In an aspect, each package comprises from two to 4 eggs.

In an aspect, the present process is carried out as part of a commercial production system wherein at least about 4,000 eggs are packaged to provide finished product per hour in a single operation line. In an aspect, the present process is carried out as part of a commercial production system wherein about 5,000 to 10,000 eggs are packaged per hour to provide finished product in a single operation line. In an aspect, the present process is carried out as a continuous line production process. In an aspect, the steps in FIG. 1 and FIG. 2 are carried out as a fully automated continuous production system.

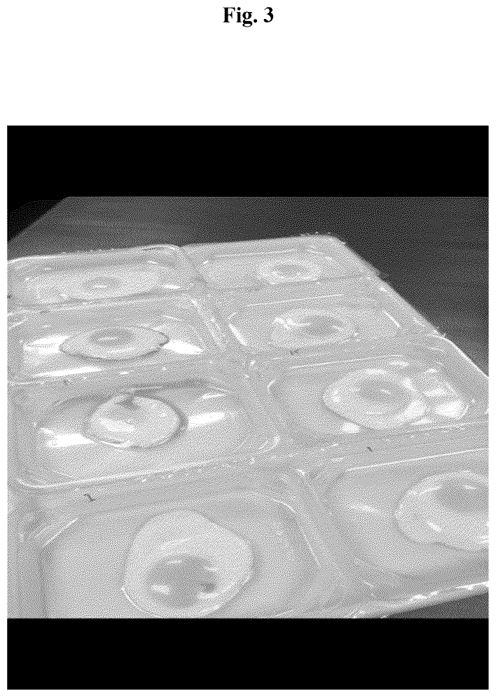

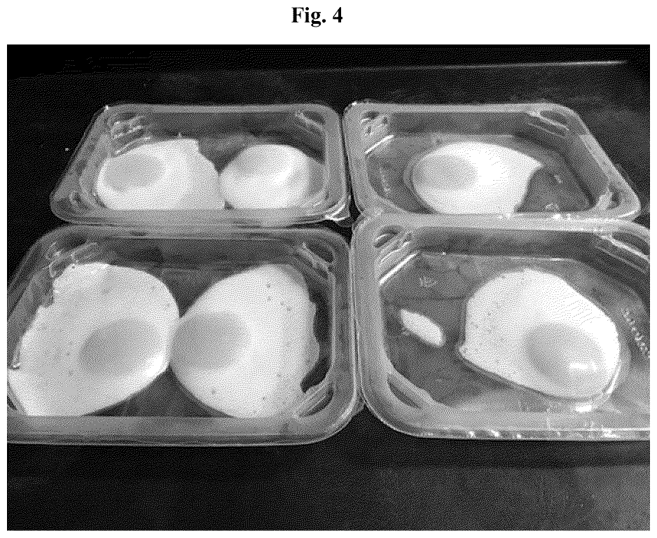

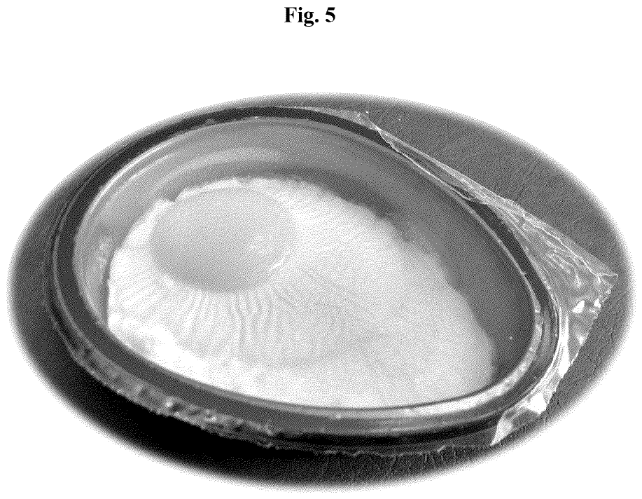

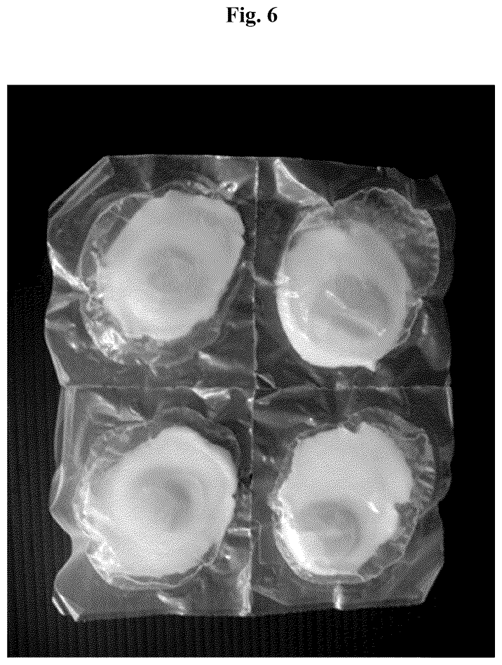

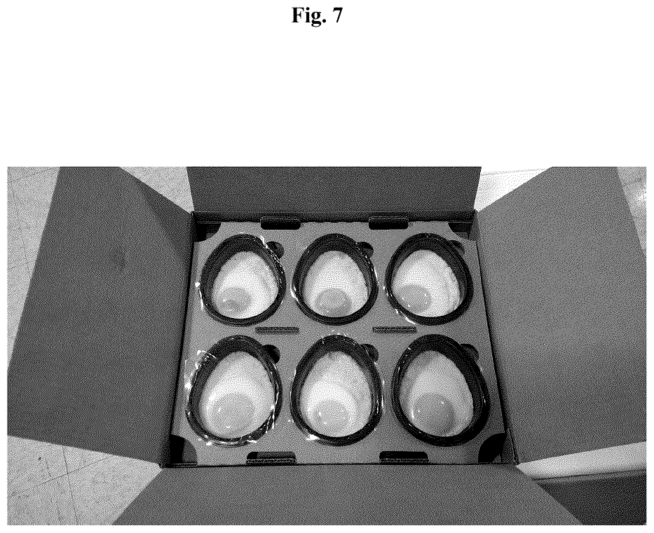

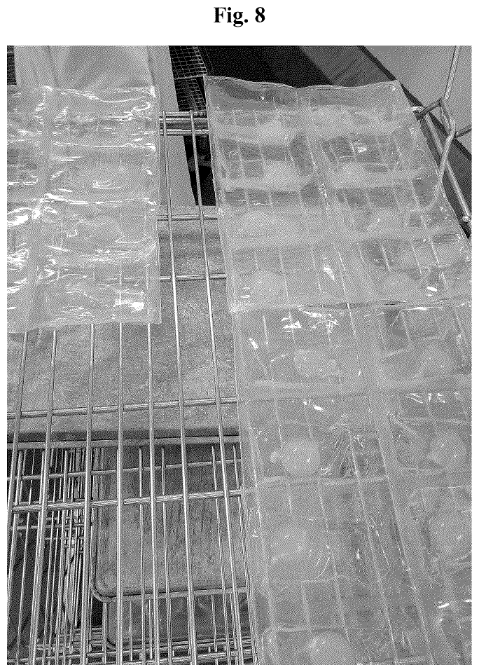

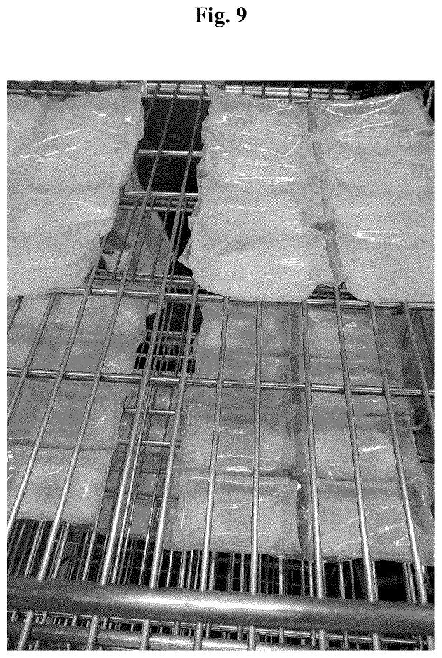

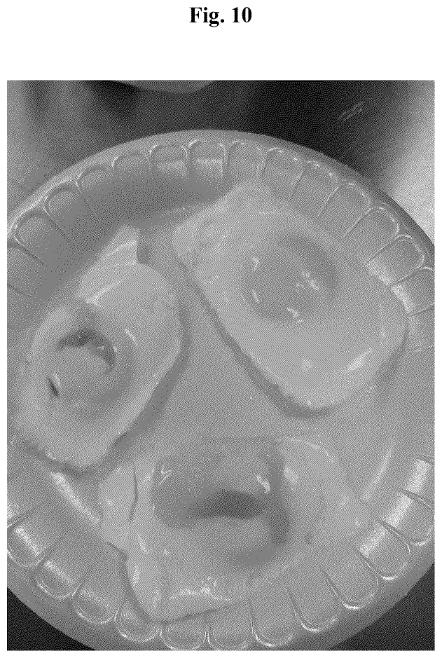

Examples of the final cooked, packaged and pasteurized eggs as described herein are shown in FIG. 3, FIG. 4, FIG. 5, FIG. 6, FIG. 7, FIG. 8, and FIG. 9. FIG. 10 shows examples of the cooked eggs after removal from the package. FIG. 3 shows a flat of connected, individually packaged eggs, with a single egg in each sealed package. In an aspect, the connected individually packaged eggs are readily detachable from each other without the need to use a tool, such as a scissors or knife. In an aspect, the connected individually packaged eggs comprise a line of weakness between each of the individual egg packages to facilitate separation. In an aspect, the line of weakness is a score line. In an aspect, the line of weakness is a perforation line. In an aspect, the individual egg packages of the connected individually packaged eggs are connected by adhesive. In an aspect, the individual egg packages of the connected individually packaged eggs are connected by adhesive tape.

FIG. 4 shows egg packages having either a single egg or two eggs in each sealed package. As shown in this aspect, the egg packages are not connected to each other, but instead are provided as separate sealed packages of eggs.

The thus provided final cooked, packaged and pasteurized eggs as described herein may be stored at refrigerated temperatures (i.e. from about 30° F. to 45° F.).

In an aspect the present process provides final cooked, packaged and pasteurized eggs that having a shelf life of at least 12 weeks as determined by having a total psychrotroph count of less than 1×10⁷ CFU/g at 12 weeks. In an aspect the present process provides final cooked, packaged and pasteurized eggs that having a shelf life of at least 16 weeks as determined by having a total psychrotroph count of less than 1×10⁷ CFU/g at 16 weeks.

In an aspect the present process provides final cooked, packaged and pasteurized eggs that having a shelf life of at least 12 weeks as determined by having a total Pseudomonas count of less than 10 CFU/g at 12 weeks. In an aspect the present process provides final cooked, packaged and pasteurized eggs that having a shelf life of at least 16 weeks as determined by having a total Pseudomonas count of less than 10 CFU/g at 16 weeks.

In an aspect the present process provides final cooked, packaged and pasteurized eggs having a shelf life of at least 16 weeks as determined by having a negative Listeria count at 16 weeks.

In an aspect the present process provides final cooked, packaged and pasteurized eggs having a shelf life of at least 12 weeks as determined by satisfying at least two of the properties selected from the group consisting of a) having a total psychrotroph count of less than 1×10⁷ CFU/g at 12 weeks; b) having a shelf life of at least 12 weeks as determined by having a total Pseudomonas count of less than 10 CFU/g at 12 weeks; and c) having a negative Listeria count at 12 weeks.

In an aspect the present process provides final cooked, packaged and pasteurized eggs that having a shelf life of at least 12 weeks as determined by satisfying all three of the properties selected from the group consisting of a) having a total psychrotroph count of less than 1×10⁷ CFU/g at 12 weeks; b) having a shelf life of at least 12 weeks as determined by having a total Pseudomonas count of less than 10 CFU/g at 12 weeks; and c) having a negative Listeria count at 12 weeks.

In an aspect the present process provides final cooked, packaged and pasteurized eggs that having a shelf life of at least 16 weeks as determined by satisfying at least two of the properties selected from the group consisting of a) having a total psychrotroph count of less than 1×10⁷ CFU/g at 12 weeks; b) having a shelf life of at least 16 weeks as determined by having a total Pseudomonas count of less than 10 CFU/g at 16 weeks; and c) having a negative Listeria count at 16 weeks.

In an aspect the present process provides final cooked, packaged and pasteurized eggs that having a shelf life of at least 16 weeks as determined by satisfying all three of the properties selected from the group consisting of a) having a total psychrotroph count of less than 1×10⁷ CFU/g at 16 weeks; b) having a shelf life of at least 16 weeks as determined by having a total Pseudomonas count of less than 10 CFU/g at 16 weeks; and c) having a negative Listeria count at 16 weeks.

In use, the thus provided final cooked, packaged and pasteurized egg product as described herein is a ready-to-eat product, though may be heated by an end user to a temperature desirable for consumption by any appropriate method, such as by microwave cooking, conventional or convection oven, cooking, skillet frying, sous vide cooking, and quick heating by brief submersion of the sealed package in water at a temperature of from about 140° F. to 212° F., and the like. In an aspect, the final heating of the cooked, packaged and pasteurized eggs by the end user is carried out to retain the texture of the yolk as being runny even after final heating. In an aspect, the final heating of the cooked, packaged and pasteurized eggs by the end user is carried out so that the egg yolk has a maximum internal temperature of no more than about 150° F.

The final cooked, packaged and pasteurized eggs as described herein are advantageous for use by end users that are institutional customers, such as restaurants and food service (such as work or school cafeterias, hospitals, and the like). The final cooked, packaged and pasteurized eggs as described herein are also advantageous for use by end users that are home consumers. In either case, the consumer is provided with an extremely convenient soft cooked egg product having a runny yolk that is provided in a predictable degree of cooking and in a format that can be difficult to consistently prepare under typical working conditions in the industrial kitchen or the home environment. The product is ready-to-eat and food safe. In addition, the present process provides a product having a reliable appearance, degree of done-ness, texture and flavor, which can be easily and quickly heated and presented for consumption by the diner.

### EXAMPLES

### Example 1: Pasteurization

### A. General

Effective pasteurization is typically determined by a reduction in the number of bacteria present in the sample, before and after pasteurization. The pasteurized cooked, packaged egg product was tested initially (i.e., Day 0) for total plate counts (TPC) (aerobic plate counts), coliforms, E. coli, Salmonella and Listeria. In addition, the pasteurized cooked, packaged egg product was tested for at least psychrotrophs and Pseudomonas for 16 weeks.

### B. Sample Preparation

Individual eggs were prepared by a) Removing an egg from its shell to provide a shell-less egg; b) Cooking the shell-less egg at a time and temperature sufficient to provide a cooked egg wherein the egg white has a maximum temperature of no more than about 175° F. and the egg yolk has a maximum internal temperature of no more than about 150° F. ; c) Cooling the cooked egg to an internal temperature of 75° F. or less; d) Sealing the cooked egg in a package; and e) Pasteurizing the cooked, packaged egg, wherein the process is carried out under processing conditions such that the pasteurized, cooked, packaged egg has a runny yolk.

A control product was prepared by all of the above steps except step e), the Pasteurizing step.

### C. Testing Preparation

Refrigerated samples were cleaned with alcohol, as well as the scissors. A 1:10 dilution of each sample was prepared. Additional appropriate dilutions were prepared from the initial 1:10 dilution by pipetting either 1 ml or 11 ml into a 99ml dilution blank to ensure that at least 1 plate would have 15 or 25 to 250 colonies. 1 ml portions of these dilutions were pipetted into appropriately labelled plates/petrifilms as follows:
For Total Anaerobic Plate Count (“TPC”)=1 ml pipetted into 3M™ Petrifilm Aerobic Count Plates and incubated at 35±1° C. for 48±3 hours.
For Coliform=1 ml pipetted into 3M™ Petrifilm™ Coliform Count Plates and incubated at 35±1° C. for 24±2 hours.
For E. coli=1 ml pipetted into 3M™ Petrifilm™ E. coli Count Plates and incubated at 35±1° C. for 48±2 hours.
For Salmonella=The procedure, AOCS 2004.03, was used for preparing samples.
For Listeria=The procedure, AOCS 2004.06, was used for preparing samples.
For Psychrotrophs=1.0 ml pipetted into 3M™ Petrifilm™ Psychrotroph Count Plates and incubated at 21±2° C. for 72±3 hours.
For Pseudomonas=0.5 ml pipetted and spread onto PIA agar plate using streaking rod, inverted and incubated at 21±2° C. for 72±3 hours.
   1. Pseudomonas isolation agar was prepared by suspending 48.4 grams of agar powder (Oxoid™ Agar) and 12.5 grams of glycerol in 1 L of distilled or deionized water at 25° C. The suspension was boiled to dissolve the ingredients and sterilized by autoclaving at 121° C. for 15 minutes. The medium was allowed to cool to 50° C. To the cooled medium, the contents of 2 vials of rehydrated Pseudomonas (Oxoid™ C-F-C Supplement reconstituted as directed) were added, mixed, and poured into sterile petri dishes (plates), and allowed to solidify.

After the correct incubation times and temperatures, the number of colonies were counted and recorded.

### C. Testing Results

The pasteurized soft-cooked packaged egg product having a runny yolk (e.g., sunny side-up egg product) exhibited excellent shelf life, with no out-of-specification results for at least 16 weeks. Specifically, the product prepared as described above, on Day 0, had a TPC count of less than 1×10⁴ CFU/g, a total coliform count of less than 100 CFU/g; a total E. coli count of less than 10 CFU/g; a negative Salmonella count; and a negative Listeria count (all acceptable counts). At 16 weeks, the product prepared as described above had a total psychrotroph count of less than 1×10⁷ CFU/g and a total Pseudomonas count of less than 10 CFU/g (all acceptable counts). In contrast, the control samples showed formation of colonies of psychrotrophs at 8 weeks, and the control samples failed at 12 weeks as shown by the formation of colonies of psychrotrophs and Pseudomonas, where, by 12 weeks, the control samples had a total psychrotroph count significantly greater than 1×10⁷ CFU/g and a total Pseudomonas count significantly greater than 10 CFU/g. At 16 weeks, the control samples further increased in total psychrotroph count and in total Pseudomonas count compared to at 12 weeks.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, and variations in sample height. For example, “about” can mean greater or lesser than the value or range of values stated by 1/10 of the stated values but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

### Example 2: Laboratory Scale-Up Test This was Done in a Pilot Plant

The eggs are packaged from the shell into film prior to the cook step (FIG. 8). The packaging specification is 8-millimeter bottom and 4 mil on top. The tooling used to make the pocket dimensions is 3 ¼″×5″ rectangle pocket and the depth is 1 ⅜″. Pan release spray is used in the bottom, then cracked eggs are transferred into the formed pockets. A smoke house (batch oven) is used to cook the eggs in the packaging. The oven is heated to 195 F using 100% steam (however, when samples are put in the oven, the actual temperature may be 155 F or lower because of heat loss due to opening the oven door). The temperature come up time is about 5 minutes to recover, so the eggs may be in a warmer cooler than desired oven for 5 minutes, causing a longer cook time than expected. The eggs are about 40F at start of cook time and the target time after the samples are in the oven is about 8 minutes.

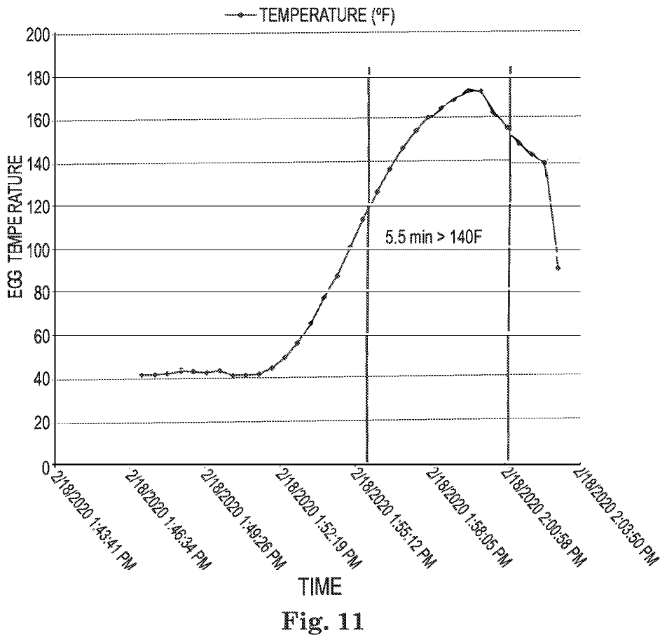

FIGS. 9 and 10 show the eggs post-cooking and after removal from the packaging. The egg temperature is greater than 140 F for about 5.5 minutes (temperature data is shown in FIG. 11).

### Additional Examples

The following exemplary examples are provided, the numbering of which is not to be construed as designating levels of importance:

Example 1 provides a process for preparing a soft cooked egg product having a runny yolk, comprising: a) Removing an egg from its shell to provide a shell-less egg; b) Cooking the shell-less egg for a time and temperature sufficient to provide a cooked egg wherein the egg white has a maximum temperature of no more than about 175° F. and the egg yolk has a maximum internal temperature of no more than about 150° F. ; c) Cooling the cooked egg to an internal temperature of 75° F. or less; d) Sealing the cooked egg in the package; and e) Pasteurizing the cooked, packaged egg; wherein the process is carried out under processing conditions such that the pasteurized, cooked, packaged egg has a runny yolk.

Example 2 provides a process for preparing a soft cooked egg product having a runny yolk, comprising: a) Removing an egg from its shell to provide a shell-less egg; b) Depositing the shell-less egg into a rigid, semi-rigid, or flexible package; c) Sealing the egg in the package; d) Cooking the shell-less egg at for a time and temperature sufficient to provide a cooked egg wherein the egg white has a maximum temperature of no more than about 175° F. and the egg yolk has a maximum internal temperature of no more than about 150° F. ; e) Optionally, cooling the cooked, packaged egg to an internal temperature of less than 45° F. ; wherein the process is carried out under processing conditions such that the cooked pasteurized packaged egg has a runny yolk. Example 2a provides the process of Example 2, wherein step is not optional

Example 3 provides any of the preceding Examples, wherein the Cooking Step is carried out at an ambient oven cooking temperature of from 160° F. to 450° F.

Example 4 provides any of the preceding Examples, wherein the Cooking Step is carried out in an impingement oven at an oven temperature of from about 300° F. to 450° F., at a steam pressure of from about 3 to 10 lbs steam.

Example 5 provides any of the preceding Examples, wherein the Cooking Step is carried out for a time of from 3 to 10 minutes.

Example 6 provides any of the preceding Examples, wherein the cooling of the Cooling Step c) is carried out in a blast chill tunnel.

Example 7 provides any of the preceding Examples, wherein the cooked egg is sealed in a tray package sealed with a skin in sealing step d).

Example 8 provides any of the preceding Examples, wherein the egg is vacuum sealed in a package that is a pouch package in the sealing step.

Example 9 provides any of the preceding Examples, wherein the egg is vacuum sealed in the sealing step under a vacuum of from 1 to 1000 mbar.

Example 10 provides any of the preceding Examples, wherein the egg is sealed in a package flushed with modified atmosphere.

Example 11 provides any of the preceding Examples, wherein the cooked egg is treated by application of water or oil to the surface of the yolk after the Cooking step b) and before the sealing step d).

Example 12 provides any of the preceding Examples, wherein the cooked egg is treated by application of water or oil to the surface of the yolk after the Cooling step c) and before the sealing step d).

Example 13 provides any of the preceding Examples, wherein the pasteurizing step e) comprises immersing the cooked, packaged egg in a heated liquid at a temperature of from 130° F. to 150° F. for a period of from 2 to 30 minutes.

Example 14 provides any of the preceding Examples, wherein the pasteurizing step e) comprises immersing the cooked, packaged egg in a heated liquid at a temperature of from 140° F. to 145° F. for a period of from 2 to 10 minutes.

Example 15 provides any of the preceding Examples, wherein the heated liquid is water.

Example 16 provides any of the preceding Examples, wherein the pasteurizing step e) comprises exposing the cooked, packaged egg to a temperature of 140° to 150° F. for a period of from 1-4 minutes.

Example 17 provides any of the preceding Examples, wherein each package comprises a single egg.

Example 18 provides any of the preceding Examples, wherein each package comprises a plurality of eggs.

Example 19 provides any of the preceding Examples, wherein the process is carried out as part of a commercial production system wherein at least about 4,000 eggs are packaged to provide finished product per hour in a single operation line.

Example 20 provides any of the preceding Examples, wherein the final cooked, packaged and pasteurized eggs have a shelf life of at least 16 weeks as determined by a psychrotrophic count of less than 1×10⁷ CFU/g at 16 weeks.

Example 21 provides any of the preceding Examples, wherein the Cooking Step is carried out at an ambient oven cooking temperature of from 180° F. to 220° F.

Example 22 provides any of the preceding Examples, wherein the Cooking Step is carried out at an ambient oven cooking temperature of from 190° F. to 200° F.

Example 23 provides any of the preceding Examples, wherein the Cooking Step is carried out at an ambient oven cooking temperature of from 192° F. to 197° F.

Example 24 provides any of the preceding Examples, wherein the Cooking Step is carried out at an ambient oven cooking temperature of about 195° F.

Example 25 provides any of the preceding Examples, wherein the Cooking Step is carried out for a time of 4 to 8 minutes.

Example 26 provides any of the preceding Examples, wherein the Cooking Step is carried out for a time of 5 to 7 minutes.

Example 27 provides any of the preceding Examples, wherein the Cooking Step is carried out for a time of 4 to 8 minutes at an egg temperature of at least 140° F.

Example 28 provides any of the preceding Examples, wherein the Cooking Step is carried out for a time of 5 to 7 minutes at an egg temperature of at least 140° F.

Example 29 provides any of the preceding Examples, wherein the final cooked, packaged and pasteurized eggs have a shelf life of at least 16 weeks as determined by a Pseudomonas count of less than 10 CFU/g.

Example 30 provides the product made by the process of any of the preceding Examples.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A process for preparing a soft-cooked egg product having a runny yolk, comprising:
a) removing an egg from its shell to provide a shell-less egg;
b) sealing the shell-less egg in a gas impermeable package flushed with an inert gas; and
c) cooking the shell-less egg in the sealed package by:
i) exposing the shell-less egg in the sealed package to a temperature between 130° F. and 145° F. for 2 to 20 minutes in the presence of steam; or
ii) exposing the shell-less egg in the sealed package to a temperature between 160° F. and 300° F. for 3 to 10 minutes in the presence of steam,
wherein the egg white has a maximum temperature during cooking of no more than 175° F. and the egg yolk has a maximum internal temperature during cooking of no more than about 150° F.,
whereby a soft-cooked egg product in a sealed package is produced, the soft-cooked egg product having an egg white that is cooked and a yolk that is runny.

2. The process of claim 1, wherein the cooking of step (c) is carried out for 4 to 8 minutes at an egg temperature of at least 140° F.

3. The process of claim 1, wherein the cooking of step (c) is carried out in an impingement oven at a steam pressure of from about 3 to 10 lbs steam.

4. The process of claim 1, wherein the cooking of step (c) is carried out for 3 to 10 minutes.

5. The process of claim 1, wherein the cooking of step (c) is carried out for 4 to 8 minutes.

6. The process of claim 1, wherein the shell-less egg is sealed in a tray package sealed with a film in step (b).

7. The process of claim 1, wherein the shell-less egg is vacuum sealed in step (b) a package that is a pouch package.

8. The process of claim 1, wherein the shell-less egg is vacuum sealed in step (b) under a vacuum of from 1 to 1000 mbar.

9. The process of claim 1, wherein the shell-less egg is vacuum sealed in step (b) under a vacuum from 800 to 1000 mbar.

10. The process of claim 1, wherein the inert gas comprises carbon dioxide and nitrogen.

11. The process of claim 1, wherein the inert gas comprises 20-40% carbon dioxide and 80-20% nitrogen.

12. The process of claim 1, wherein the soft-cooked egg product in a sealed package has a shelf life of at least 16 weeks as determined by a psychrotrophic count of less than 1x107 CFU/g at 16 weeks.

13. The process of claim 1, wherein the soft-cooked egg product in a sealed package has a shelf life of at least 16 weeks as determined by a Pseudomonas count of less than 10 CFU/g at 16 weeks.

14. The process of claim 1, further comprising cooling the cooked shell-less egg in a sealed package to an internal temperature of less than 45° F.

15. The process of claim 1, wherein during cooking in step (c) the egg is cooked without turning the egg over such that the soft-cooked egg product has the appearance of a sunny-side up egg.

16. The process of claim 1, wherein the cooking of step (c) is carried out in a continuous steam oven.

17. The process of claim 1, wherein the cooking of step (c) is carried out in a batch oven.
